(19) United States
(12) Patent Application Publication
(10) Pub. No.: US 2019/0226498 A1
(43) Pub. Date: Jul. 25, 2019

(54) BLOWER MACHINE

(71) Applicant: MAKITA CORPORATION, Anjo-shi (JP)

(72) Inventor: Hideaki TAKANO, Anjo-shi (JP)

(73) Assignee: MAKITA CORPORATION, Anjo-shi (JP)

(21) Appl. No.: 16/253,571

(22) Filed: Jan. 22, 2019

(30) Foreign Application Priority Data
Jan. 23, 2018 (JP) 2018-009167

(51) Int. Cl. F04D 29/66

(52) U.S. Cl. CPC F04D 29/664; A01G 20/47

(57) ABSTRACT

A blower machine may include a blower unit configured to blow air; and an air passage pipe connected to an air duct of the blower unit. The air passage pipe may include an elbow pipe arranged on a proximal end side of the air passage pipe which is connected to the air duct; and a straight pipe extending straight and arranged on a distal end side of the air passage pipe than the elbow pipe. A first silencer pipe portion may be arranged at a proximal end portion of the straight pipe which is arranged on the distal end side of the air passage pipe than the elbow pipe, and the first silencer pipe portion may be provided with a sound absorbing material on an inner surface of the first silencer pipe.

### CROSS-REFERENCE TO RELATED APPLICATION

This application claims priority to Japanese Patent Application No. 2018-009167, filed on Jan. 23, 2018, the entire contents of which are hereby incorporated by reference into the present application.

### TECHNICAL FIELD

The teachings disclosed herein relate to a blower machine such as a blower and a dust collector, and relate to a blower machine in which an air passage pipe connected to an air duct of a blower unit includes an elbow pipe and a straight pipe located on a distal end side than the elbow pipe.

### BACKGROUND ART

Japanese Patent Application Publication No. 2015-083816 describes a blower configured to gather fallen leaves by blowing air. The blower is provided with a blower unit mounted on a backpack frame and configured to blow air, and an air passage pipe connected to an air duct portion of the blower unit. The blower is configured to discharge the air from the blower unit from a distal end of the air passage pipe.

### SUMMARY

As blower machines similar to the blower described in Japanese Patent Application Publication No. 2015-083816, blower machines have been developed to reduce noise generated therefrom as much as possible, for example, by replacing their engines, which are prime movers of the blower units, with electric motors to reduce driving sound. However, no blower machine that can sufficiently reduce noise of airflow flowing through an air passage pipe has yet been developed. Especially in each blower machine similar to the blower described in Japanese Patent Application Publication No. 2015-083816, an elbow pipe is arranged on a proximal end side of the air passage pipe, a straight pipe is arranged on a distal end side of the air passage than the elbow pipe, and a standing wave, which is generated by combination of an incident wave generated by rotation of a fan in the blower unit and a reflected wave generated by the incident wave reflecting at a curved portion of the elbow pipe, is amplified in the air passage pipe, which results in a large airflow noise. The teachings disclosed herein aim to reduce an airflow noise generated by air flowing through an air passage pipe of a blower machine.

To solve the above problem, the teachings disclosed herein provide a blower machine. The blower machine may comprise a blower unit configured to blow air, and an air passage pipe connected to an air duct of the blower unit. The air passage pipe may comprise an elbow pipe arranged on a proximal end side of the air passage pipe which is connected to the air duct, and a straight pipe extending straight and arranged on a distal end side of the air passage pipe than the elbow pipe. A first silencer pipe portion may be arranged at a proximal end portion of the straight pipe which is arranged on the distal end side of the air passage pipe than the elbow pipe, and the first silencer pipe portion may be provided with a sound absorbing material on an inner surface of the first silencer pipe.

In the blower machine configured as above, the first silencer pipe portion, which has the sound absorbing material provided on the inner surface thereof, is provided at the proximal end portion of the straight pipe that is on the distal end side of the air passage pipe than the elbow pipe, and thus an airflow noise generated by air flowing through the air passage pipe can be reduced.

### BRIEF DESCRIPTION OF THE DRAWINGS

FIG. 1 shows a side view of a backpack type blower of a first embodiment, which is an embodiment of the blower machine disclosed herein.

FIG. 2 shows a cross-sectional view of a silencer along an axial direction.

FIG. 3 shows a side view of a backpack type blower of a second embodiment.

### EMBODIMENTS

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved blower machines, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

According to an embodiment of the present disclosure, a second silencer pipe portion may be further arranged at a distal end portion of the straight pipe. The second silencer pipe portion may be provided with the sound absorbing material on an inner surface of the second silencer pipe portion. With such a configuration, the airflow noise that is generated in the straight pipe by amplification of a standing wave, which is generated by combination of an incident wave and a reflected wave, can be reduced. In a case of such a configuration, at least one of lengths of the first silencer pipe portion provided at the proximal end portion of the straight pipe and the second silencer pipe portion provided at the distal end portion of the straight pipe may be equal to or longer than ¼ of a length of the straight pipe.

According to an embodiment of the present disclosure, a coating film having a thickness of 100 μm or less may be provided on a surface of the sound absorbing material. With such a configuration, the coating film vibrates by receiving an air pressure change, by which sound absorption is achieved by heat exchange loss in the coating film and the airflow noise generated by the air flowing through the air passage pipe can further be reduced.

According to an embodiment of the present disclosure, a grip handle configured to be gripped by a worker may be provided on an outer surface of the first silencer pipe provided at the proximal end portion of the straight pipe. In this case, the grip handle may be configured to slidably attach to the first silencer pipe portion along an axial direction of the first silencer pipe portion provided at the proximal end portion of the straight pipe such that a position of the grip handle is adjustable.

### FIRST EMBODIMENT

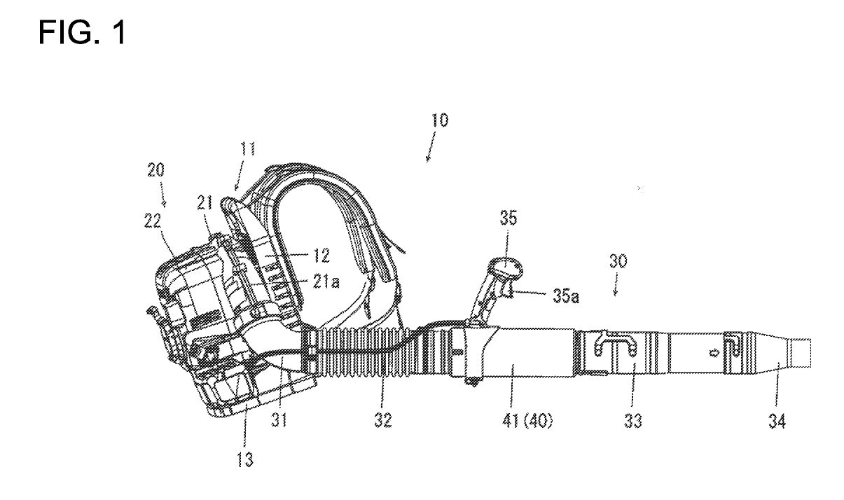

Hereinbelow, a backpack type blower of a first embodiment, which is an embodiment of the blower machine disclosed herein, will be described with reference to the attached drawings. As shown in FIG. 1, a backpack type blower 10 includes a backpack frame 11 configured to be worn on a back of a worker, a blower unit 20 mounted on the backpack frame 11, an air passage pipe 30 connected to an air duct 21a of the blower unit 20, and a silencer 40 attached to the air passage pipe 30. The backpack frame 11 is for the worker to carry the blower unit 20 on the worker's back. The backpack frame 11 is constituted of a back plate 12 arranged along the worker's back and a seat 13 extending rearward from a lower end of the back plate 12, and has an L shape when seen in its side view. A volute 21 is mounted at a front side of the seat 13 of the backpack frame 11.

As shown in FIG. 1, the blower unit 20 is provided with the volute 21, an impeller (not shown) rotatably provided in the volute 21, and a prime mover 22 configured to rotate the impeller. The air duct 21a is provided on a side portion of the volute 21, and air blown out in a centrifugal direction by rotation of the impeller in the volute 21 is discharged from the air duct 21a.

As shown in FIG. 1, the air duct 21a has the air passage pipe 30 connected thereto, and the air passage pipe 30 includes an elbow pipe 31 rotatably connected to the air duct 21a, a bellows pipe 32 connected to the elbow pipe 31 a straight pipe 33 connected to the bellows pipe 32, and a nozzle 34 connected to a distal end of the straight pipe 33. The straight pipe 33 is provided with the silencer 40 at its proximal end portion on an air duct 21a side. Further, an operation handle (grip handle) 35 is provided at a position where the silencer 40 is provided at the proximal end portion of the straight pipe 33, and the operation handle 35 is configured to move the air passage pipe 30. Further, a throttle lever 35a is provided on the operation handle 35, and an output of the prime mover 22 is adjusted by operation of the throttle lever 35a. In this embodiment, the operation handle 35 is attached to a portion where the silencer 40 is provided on a proximal end side.

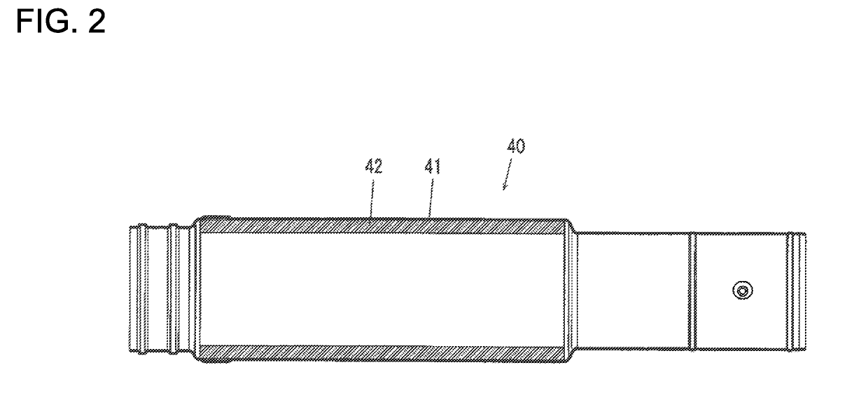

As shown in FIGS. 1 and 2, the silencer 40 is configured to reduce a noise of airflow flowing through the air passage pipe 30, and is provided at the proximal end portion of the straight pipe 33. The silencer 40 is connected to the bellows pipe 32 at the proximal end portion of the straight pipe 33. The silencer 40 is provided with a silencer pipe portion 41 having a cylinder shape and a sound absorbing material 42 attached to an inner surface of the silencer pipe portion 41. The silencer pipe portion 41 of the silencer 40 is a portion where the sound absorbing material 42 is provided. The sound absorbing material 42 is constituted of a foamed polyurethane material having a thickness of 10 mm, and has a function to absorb and reduce the noise of the airflow flowing through the silencer pipe portion 41. A coating film having a thickness of 100 μm and a smooth surface is provided on a surface of the sound absorbing material 42, and the coating film on the surface of the sound absorbing material 42 has a function to absorb sound by heat exchange loss in the coating film by vibrating by receiving an air pressure change.

The silencer pipe portion 41 of the silencer 40 provided at the proximal end portion of the straight pipe 33 has a length that is ⅓ of a length of the straight pipe 33 including the silencer 40 and the nozzle 34. An inner diameter of the silencer pipe portion 41 in a state where the sound absorbing material 42 is not attached is 900 mm, and the inner diameter of the silencer pipe portion 41 in a state where the sound absorbing material 42 is attached is 700 mm. The inner diameter of the portion of the silencer pipe portion 41 where the sound absorbing material 42 is provided is substantially identical to an inner diameter of the air passage pipe 30 excluding the nozzle 34, and it is configured so as not to create resistance against the airflow flowing through the silencer pipe portion 41.

A standing wave, which is constituted of an incident wave generated by rotation of a fan in the volute 21 and a reflected wave generated by the incident wave reflecting on a curved portion of the elbow pipe 31 and in the bellows pipe 32, is amplified in the air passage pipe 30. The proximal end portion of the straight pipe 33 is in a half-closed state by the curved portion of the elbow pipe 31 and the bellows pipe 32 and a distal end portion of the straight pipe 33 is in an open state, as a result of which a compressional wave state in the straight pipe 33 is dense on its proximal end side relative to a center portion of the straight pipe 33 in an axial direction and sparse at both end sides. The air passage pipe 30 herein can suppress the reflected wave reflecting on the curved portion in the elbow pipe 31 and in the bellows pipe 32 by providing the silencer 40 at the proximal end portion of the straight pipe 33 at a low level.

An operation of the backpack type blower 10 configured as above will be described. When the prime mover 22 is driven by the throttle lever 35a being operated, the impeller rotates, air that was suctioned from an air suction opening on a front side of the volute 21 is blown out in the centrifugal direction by the rotating impeller, the air that was blown out has its pressure increased in a volute air passage and is discharged to the air duct 21a, and the air that was blown out from the air duct 21a flows through the air passage pipe 30 and is blown out toward a ground. When the worker grips the operation handle 35 of the air passage pipe 30 and swings a distal end opening thereof left and right in front of the worker, fallen leaves scattered over a large area on the ground can be gathered.

In the backpack type blower 10 configured as above, the silencer pipe portion 41 including the sound absorbing material 42 on its inner surface is arranged on a distal end side of the air passage pipe 30 than the elbow pipe 31. With such a configuration, the airflow noise generated by the air flowing in the air passage pipe 30 can be reduced. Especially in this embodiment, the silencer 40 provided at the proximal end portion of the straight pipe 33 can efficiently absorb the reflected wave reflected in the elbow pipe 31 and the bellows pipe 32, by which the airflow noise generated by the air flowing in the air passage pipe 30 can be reduced. Further, although the standing wave, which is composed of the incident wave generated by the rotation of the fan in the volute 21 and the reflected wave reflected in the elbow pipe 31 and the bellows pipe 32, is amplified in the straight pipe 33 and the airflow noise generated thereby is increased, the airflow noise generated by the amplified standing wave can efficiently be reduced since the silencer 40 is arranged at the proximal end portion of the straight pipe 33. Further, since the length of the silencer pipe portion 41 provided at the proximal end portion of the straight pipe 33 is equal to or longer than ¼, more specifically, is ⅓, of the length of the straight pipe 33 including the silencer pipe portion 41, the airflow noise caused by the standing wave in the straight pipe 33 can efficiently be reduced. The same effect can be achieved with a configuration in which the length of the silencer pipe portion 41 is equal to or longer than ¼ of the straight pipe 33, although the length of the silencer pipe portion 41 will be longer. Furthermore, since the coating film with the thickness of 100 μm or less is provided on the surface of the sound absorbing material 42, this coating film vibrates by receiving the air pressure change by which sound can be absorbed by the heat exchange loss in the coating film. as a result of which the airflow noise generated by the air flowing in the air passage pipe 30 can further be reduced.

Further, the operation handle (grip handle) 35 which the worker grips is attached to an outer surface of the silencer pipe portion 41 provided at the proximal end portion of the straight pipe 33. By setting the thickness of the sound absorbing material 42 provided on the inner surface of the silencer pipe portion 41 to 10 mm, an outer diameter of the silencer pipe portion 41 can be suppressed from becoming excessively large, and the operation handle 35 can be arranged as close to the air passage pipe 30 as possible even when the operation handle 35 is attached to the silencer pipe portion 41. Further, the operation handle 35 is configured to be movably attached along the axial direction of the silencer pipe portion 41 and a position of the operation handle 35 is thereby adjustable, by which workability upon working by gripping the operation handle 35 can be improved. The operation handle 35 may not be provided with the throttle lever 35a.

### SECOND EMBODIMENT

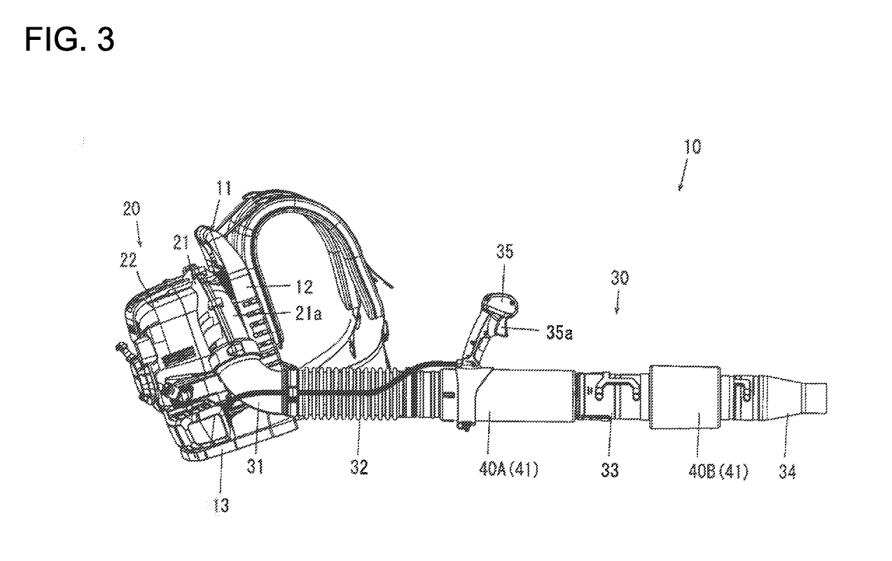

Next, a backpack type blower 10 of a second embodiment will be described. As shown in FIG. 3, in the backpack type blower 10 of the second embodiment, the straight pipe 33 includes silencers 40 provided respectively at the proximal end portion thereof on the air duct 21a side and at the distal end portion thereof on an air discharging side (the silencer on the proximal end side is indicated by 40A (which is the same as the silencer 40 in the first embodiment), and the silencer on the distal end side is indicated by 40B). A length of the silencer pipe portion 41 of the silencer 40A provided at the proximal end portion is ⅓ of the length of the straight pipe 33 including the silencers 40 and the nozzle 34, and a length of the silencer pipe portion 41 of the silencer 40B provided at the distal end portion is ⅕ of the length of the straight pipe 33 including the silencers 40 and the nozzle 34.

As aforementioned, the standing wave, which is constituted of the incident wave generated by the rotation of the fan in the volute 21 and the reflected wave generated by the incident wave reflecting on the curved portion in the elbow pipe 31 and in the bellows pipe 32, is amplified in the air passage pipe 30. The proximal end portion of the straight pipe 33 is in the half-closed state by the curved portion of the elbow pipe 31 and the bellows pipe 32 and the distal end portion of the straight pipe 33 is in the open state, as the result of which the compressional wave state in the straight pipe 33 is dense on the proximal end side relative to the center portion in the axial direction and sparse at the both end sides. This air passage pipe 30 can suppress the reflected wave reflecting on the curved portion in the elbow pipe 31 and in the bellows pipe 32 at a low level by providing the silencer 40A at the proximal end portion of the straight pipe 33 as well as can reduce the airflow noise generated by the standing wave amplified in the air passage pipe 30 by providing the silencer 40B at the distal end portion of the straight pipe 33. Other configurations are the same as those of the backpack type blower 10 of the first embodiment as aforementioned.

In this second embodiment, not only can the same effect as the backpack type blower 10 of the first embodiment be achieved, but also the airflow noise generated by the amplified standing wave can efficiently be reduced by providing the silencers 40 (40A, 40B) at both the proximal end portion and distal end portion of the straight pipe 33. Further, as at least one of the silencer pipe portions 41 provided at the proximal end portion and the distal end portion of the straight pipe 33, the silencer pipe portion 41 provided at the proximal end portion is equal to or longer than ¼, more specifically, is ⅓, of the length of the straight pipe 33 including the silencer pipe portions 41, and thus the airflow noise caused by the standing wave in the straight pipe 33 can efficiently be reduced. The same effect can be achieved with a configuration in which the length of the silencer pipe portion 41 of the silencer 40B is equal to or longer than ¼ of the length of the straight pipe 33, although the length of the silencer pipe portion 41 of the silencer 40B at the distal end portion will be longer.

The blower machine disclosed herein is not limited to the backpack type blowers 10 in the embodiments, and may be a handheld blower. Further, the blower machine disclosed herein may be a backpack-type dust collector or a handheld dust collector. In this case, a dust collecting pipe (having the same configuration as the aforementioned air passage pipe) is connected to the air duct of the blower unit, and air is suctioned from the air duct of the blower unit through the dust collecting pipe.

What is claimed is:

1. A blower machine comprising:
a blower unit configured to blow air; and
an air passage pipe connected to an air duct of the blower unit,
wherein
the air passage pipe comprises:
an elbow pipe arranged on a proximal end side of the air passage pipe which is connected to the air duct; and
a straight pipe extending straight and arranged on a distal end side of the air passage pipe than the elbow pipe.
a first silencer pipe portion is arranged at a proximal end portion of the straight pipe which is arranged on the distal end side of the air passage pipe than the elbow pipe, and
the first silencer pipe portion is provided with a sound absorbing material on an inner surface of the first silencer pipe.

2. The blower machine according to claim 1, wherein
a second silencer pipe portion is further arranged at a distal end portion of the straight pipe, and
the second silencer pipe portion is provided with a sound absorbing material on an inner surface of the second silencer pipe portion.

3. The blower machine according to claim 2, wherein
at least one of lengths of the first silencer pipe portion and the second silencer pipe portion is equal to or longer than ¼ of a length of the straight pipe.

4. The blower machine according to claim 1, wherein
a coating film having a thickness of 100 μm or less is provided on a surface of the sound absorbing material.

5. The blower machine according to claim 1, wherein
a grip handle configured to be gripped by a worker is provided on an outer surface of the first silencer pipe.

6. The blower machine according to claim 5, wherein
the grip handle is configured to slidably attach to the first silencer pipe portion along an axial direction of the first silencer pipe portion such that a position of the grip handle is adjustable.
